(19) United States
(12) Patent Application Publication
(10) Pub. No.: US 2006/0262387 A1
(43) Pub. Date: Nov. 23, 2006

(54) Optical amplifier fiber

(75) Inventors: Tetsuya Haruna, Yokohama-shi (JP); Toshiki Taru, Bath (GB); Masashi Onishi, Yokohama-shi (JP); Motoki Kakui, Yokohama-shi (JP); Shinji Ishikawa, Yokohama-shi (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD.

(21) Appl. No.: 11/434,073

(22) Filed: May 16, 2006

(30) Foreign Application Priority Data
May 18, 2005 (JP) 2005-145663

(51) Int. Cl. H01S 3/00; H04B 10/12

(52) U.S. Cl. 359/341.1

(57) ABSTRACT

Provided is an optical amplifier fiber in which both increasing output light power and sufficiently inhibiting the occurrence of nonlinear optical phenomenon can be compatibly achieved. In addition, an optical amplifier and light source equipment, in which such optical amplifier fiber is used, are provided. The optical amplifier fiber comprises (1) a core region doped with an aluminum element in the range of 1 wt % to 10 wt %, an erbium element in the range of 1000 wt. ppm to 5000 wt. ppm, and a fluorine element, the core region having an outer diameter in the range of 10 μm to 30 μm, and (2) a cladding region surrounding the core region and having a refractive index that is lower than the core region, wherein the relative refractive index difference of the core region relative to the cladding region is 0.3% or more and 2.0% or less.

### BACKGROUND OF THE INVENTION

1. Field of the Invention

The present invention relates to an optical amplifier fiber the core region of which is doped with a rare earth element, and also to an optical amplifier in which the optical amplifier fiber is used as a medium for optical amplification.

2. Description of the Background Art

An optical amplifier can amplify signal light by using an optical amplifier fiber as an optical amplification medium and supplying pump light to the optical amplifier fiber. For example, an erbium doped fiber amplifier (EDFA) can amplify signal light of the 1.55 μm wavelength band generally used in an optical communication system, and is installed in an optical repeater of the optical communication system.

The required characteristics of an optical amplifier are such that its output optical power is large and such that the occurrence of nonlinear optical phenomenon in an optical amplifier fiber is inconspicuous. However, increasing the power of output light and inhibiting the occurrence of nonlinear optical phenomenon are in a trade-off relationship with each other. An optical amplifier disclosed in Japanese Patent Application Publication No. 2004-146681 fiber is intended to satisfy both of the two requirements.

The generation efficiency η of noise light due to nonlinear optical effect is proportional to the square of a fiber length L and is in inverse proportion to the square of an effective core area A_{eff}. The relationships between a fiber length L, a product P of fiber length and absorption due to erbium and an absorption peak value α are expressed by P=α×L, and the effective core area A_{eff} is proportional to the square of a mode field diameter (MFD). Thus, the nonlinear noise generation efficiency η is proportional to P²/(α²×MFD⁴). The Er-doped optical amplifier fiber is often used under the condition in which the absorption and fiber length product have a pre-determined value. In this case, the effective method for compatibly achieving both of increase in the output light power and inhibition of the occurrence of the nonlinear optical phenomenon is to increase the Er concentration of the core region as well as to expand the core diameter.

In a case where the Er concentration is increased, there is a possibility that high output power cannot be obtained since association among Er atoms occurrs, and decrease of power generation efficiency (concentration quenching) occurs. Therefore, a generally adopted method for suppressing concentration quenching in a state of high Er concentration is to increase the concentration of dopants, such as aluminum (Al) element, to be doped except for rare earth elements. However, the relative refractive index difference in the core region relative to the cladding region increases when Aluminum elements are doped to the core region, and accordingly the mode field diameter (MFD) decreases and nonlinear optical phenomenon tends to occur.

Thus, in an optical amplifier fiber disclosed in Japanese Patent Application Publication No. 2002-043660, a fluorine element in addition to Er and Al elements is doped to the core region. The optical amplifier fiber disclosed in Japanese Patent Application Publication No. 2002-043660 allows the concentration quenching to be suppressed by increasing Aluminum concentration while the output light power is increased by increasing Er concentration. Moreover, it is attempted to restrain the occurrence of the nonlinear optical phenomenon by restraining the increase of relative refractive index difference in the core region by doping fluorine, and thereby restraining the reduction of mode field diameter MFD.

However, in the optical amplifier fibers disclosed in Japanese Patent Application Publication No. 2004-146681 and Japanese Patent Application Publication No. 2002-043660, the occurrence of the nonlinear optical phenomenon cannot sufficiently be prevented when it is attempted to increase output light power.

### SUMMARY OF THE INVENTION

The objects of the present invention is to provide an optical amplifier fiber in which both increasing output light power and sufficiently inhibiting the occurrence of nonlinear optical phenomenon can be compatibly achieved, and to provide an optical amplifier, light source equipment, etc. in which such optical amplifier fiber is used.

To achieve such objects, an optical amplifier fiber of the present invention has (1) a core region which is doped with an aluminum element in the range of 1 wt % to 10 wt %, an erbium element in the range of 1000 wt. ppm to 5000 wt. ppm, and a fluorine element and which has an outer diameter in the range of 10 μm to 30 μm, and (2) a cladding region which surrounds the core region and which has a refractive index that is lower than the core region, wherein the relative refractive index difference of the core region relative to the cladding region is 0.3% or more and 2.0% or less.

The concentration of the erbium element may be 2500 wt. ppm or more and 4000 wt. ppm or less. The concentration of the aluminum element may be 4 wt % or more and 8 wt % or less. The concentration of the fluorine element may be 0.1 wt % or more and 2.5 wt % or less. Preferably, the concentration of the fluorine element is 0.3 wt % or more to 2.0 wt % or less. The relative refractive index difference of the core region relative to the cladding region may be 0.3% or more and 1.0% or less.

Another aspect of the present invention is an optical amplifier comprising (1) an optical amplifier fiber of the present invention and (2) a pump light supplying means which supplies pump light to the optical amplifier fiber.

Another aspect of the present invention is light source equipment which comprises (1) a signal generator for generating an electrical signal, (2) a semiconductor laser device for generating a laser beam based on the electrical signal, and (3) an optical fiber amplifier having an optical amplifier fiber of the present invention and used for amplifying a laser beam emitted from a semiconductor laser device.

Yet another aspect of the present invention is optical medical treatment equipment comprising (1) light source equipment of the present invention, (2) a wavelength converter for converting irradiation light emitted from an outlet part of the light source equipment into irradiation light of a given wavelength for medical treatment and (3) an irradiation light system for leading and irradiating the irradiation light, which has been converted by the wavelength converter, onto a treatment part.

A further aspect of the present invention is exposure equipment comprising (1) light source equipment of the present invention, (2) wavelength converter for converting irradiation light, which is emitted from an outlet part of the light source equipment, into irradiation light of a given wavelength, (3) a mask supporting member for holding a photomask in which a pre-determined exposure pattern is provided, (4) a holder for holding an object of exposure, (5) an illumination optical system for irradiating a photomask held by a mask supporting member with irradiation light that has been converted by the wavelength converter, and (6) a projection optical system with which irradiation light having been irradiated by the illumination optical system and having passed through the photomask is projected to an object of exposure held by an object holder.

### BRIEF DESCRIPTION OF THE DRAWINGS

These and other features, aspects, and advantages of the present invention will be better understood through the following description, appended claims, and accompanying drawings. In the explanation of the drawings, an identical mark is applied to identical elements and an overlapping explanation will be omitted.

FIG. 1 is a schematic diagram of an optical amplifier according to an embodiment of the present invention.

FIGS. 2A and 2B are schematic diagrams of an optical amplifier fiber according to an embodiment of the present invention: FIG. 2A is a sectional view of a plane which is perpendicular to the optical axis, and FIG. 2B is a graph showing a refractive index profile.

FIG. 3 is a graph showing the relationship between Er concentration and Al concentration when the excitation efficiency decreases by 5.0% due to concentration quenching.

FIG. 4 is a graph showing relationships between Al concentration and fluorine concentration, using relative refractive index differences Δn as a parameter.

FIG. 5 is a graph showing relationships between Al concentration and nonlinear noise generation efficiency η, using fluorine concentration as a parameter.

FIG. 6 is a schematic diagram of light source equipment according to an embodiment of the present invention.

FIG. 7 is a schematic diagram of optical medical treatment equipment according to an embodiment of the present invention.

FIG. 8 is a schematic diagram of a wavelength converter which is included in the optical medical treatment equipment of FIG. 7.

FIG. 9 is a schematic diagram of a luminaire and an observation optical device which are included in the optical medical treatment equipment of FIG. 7.

FIG. 10 is a schematic diagram of exposure equipment according to an embodiment of the present invention.

### DETAILED DESCRIPTION OF THE INVENTION

(Embodiments of an Optical Amplifier and an Optical Amplifier Fiber)

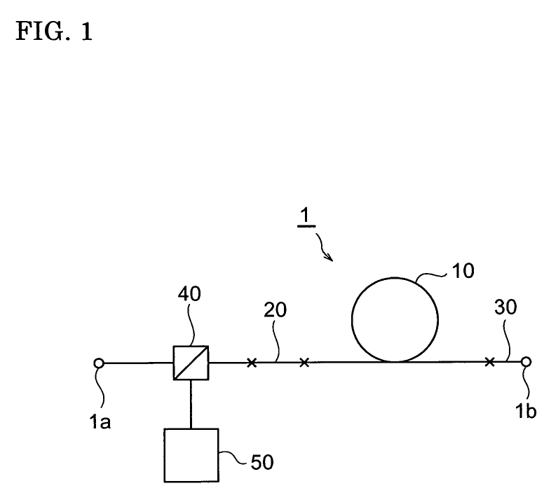

FIG. 1 is a schematic diagram of an optical amplifier according to an embodiment of the present invention. The optical amplifier 1, which comprises an optical amplifier fiber 10, connecting fibers 20 and 30, an optical coupler 40, and a pump light source 50, amplifies light input to an input end 1a and outputs the amplified light from an output end 1b.

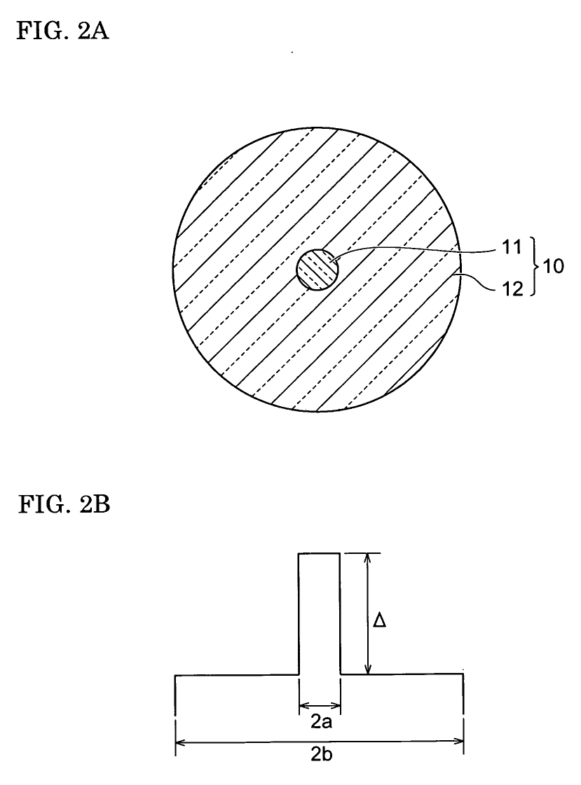

FIGS. 2A and 2B are schematic diagrams of an optical amplifier fiber according to an embodiment of the present invention: FIG. 2A is a sectional view of a plane which is perpendicular to the optical axis, and FIG. 2B is a graph showing a refractive index profile. The optical amplifier fiber 10 contains silica glass as its main component and has a core region 11 which is doped with Er, Al, and fluorine elements, and a cladding region 12 which surrounds the core region 11 and which has a lower refractive index than the core region 11. The core region may be doped with GeO₂, and the cladding region may be doped with fluorine.

The concentration of erbium doped to the core region is 1000 wt. ppm or more and 5000 wt. ppm or less, and the concentration of Al element doped to the core region is in the range of 1 wt % to 10 wt %. The outer diameter of the core region is in the range of 10 μm to 30 μm, and the outer diameter of the cladding region is 75 μm or more and less than 200 μm. The relative refractive index difference of the core region relative to the cladding region is in the range of 0.3% to 2.0% (preferably, 0.3% to 1.0%). With such composition of the optical amplifier fiber 10, it is possible to make further increase of output light power and the inhibition of occurrence of nonlinear optical phenomenon sufficiently compatible.

Preferably, the optical amplifier fiber 10 has a cutoff wavelength of 2.0 μm or more. The concentration of erbium doped to the core region is preferably in the range of 2500 wt. ppm to 4000 wt. ppm. The concentration of Al element doped to the core region is preferably in the range of 4 wt % to 8 wt %. The concentration of fluorine element doped to the core region is preferably in the range of 0.1 wt % to 2.5 wt %, and more preferably, 0.3 wt % to 2.0 wt %. Also, the relative refractive index difference of the core region relative to the cladding region is preferably in the range of 0.3% to 1.0%.

The input end 1a of the optical amplifier fiber 10 is connected with a connecting fiber 20 by fusion-splice and the optical amplifier fiber 10 is connected with the output end of an optical coupler 40 (generally, standard single mode fiber) through the connecting fiber 20. The mode field diameter of the connecting fiber 20 is greater than the mode field diameter of the output end of the optical coupler 40 and is smaller than the mode field diameter of the optical amplifier fiber 10.

The output end of the optical amplifier fiber 10 is connected with a connecting fiber 30 by fusion-splice, and the optical amplifier fiber 10 is connected with an output end 1b through the connecting fiber 30. The output end 1b is generally connected with a standard single mode fiber. The mode field diameter of the connecting fiber 30 is greater than the mode field diameter of the optical fiber connected with the output end 1b and is smaller than the mode field diameter of the optical amplifier fiber 10.

Light that has been input to the input end 1a is output to the optical amplifier fiber 10 through the optical coupler 40, and pump light that has been output from a pump light source 50 is also output to the optical amplifier fiber 10 through the optical coupler 40. The pump light source 50 outputs pump light of the 1.48 μm or 0.98 μm wavelength that can excite erbium doped to the optical amplifier fiber 10. The optical coupler 40 and the pump light source 50 constitute a pump light supplying means which supplies optical amplifier fiber 10 with pump light. The wavelength of light which is amplified in the optical amplifier fiber 10 is in a 1.5-1.6 μm band.

This optical amplifier 1 works as follows. The pump light output from the pump light source 50 is supplied to the optical amplifier fiber 10 via the optical coupler 40 and the connecting fiber 20, and excites the erbium elements doped to the optical amplifier fiber 10. The light input to the input end 1a is incident on the optical amplifier fiber 10 via the optical coupler 40 and the connecting fiber 20, and is optically amplified in the optical amplifier fiber 10. The light thus optically amplified is output from the output end 1b via the connecting fiber 30. In the present embodiment, since the connecting fibers 20 and 30 are used, the mode field diameter at both ends of the optical amplifier fiber 10 is varied on a step-by-step basis. Thus, the loss of amplification light or pump light due to the discontinuity of mode field diameter is reduced, and in this respect also, light of high power can be output.

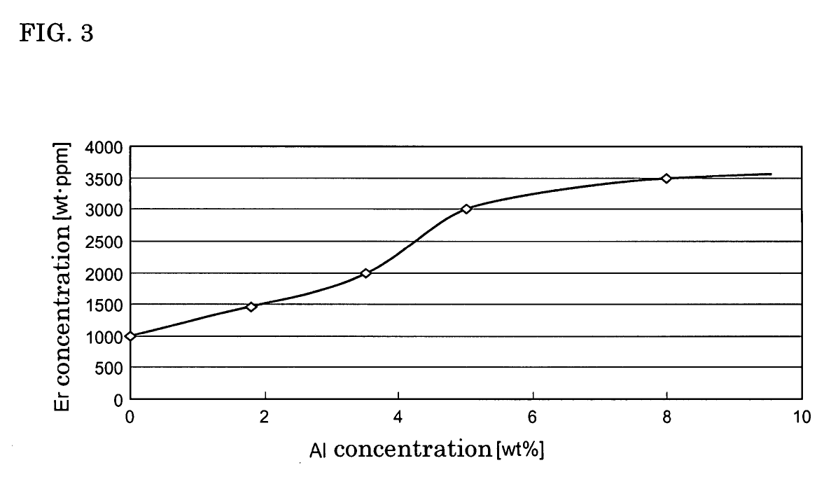

FIG. 3 is a graph showing the relationship between Er concentration and Al concentration when the excitation efficiency decreases by 5.0% due to concentration quenching. In the case where high concentration of erbium is doped to the core region, in order to restrain decrease of excitation efficiency due to concentration quenching, high concentration of Al elements must be doped to the core region according to Er concentration. In order to suppress the decrease of excitation efficiency due to concentration quenching to 5.0% or less, the aluminum concentration is 1 wt % when the Er concentration is 1000 wt. ppm. When the Er concentration is 2500 wt. ppm, 3000 wt. ppm, and 3500 wt ppm, it is necessary that the aluminum concentration is equal to or more than 4 wt %, 5 wt %, and 8 wt %, respectively.

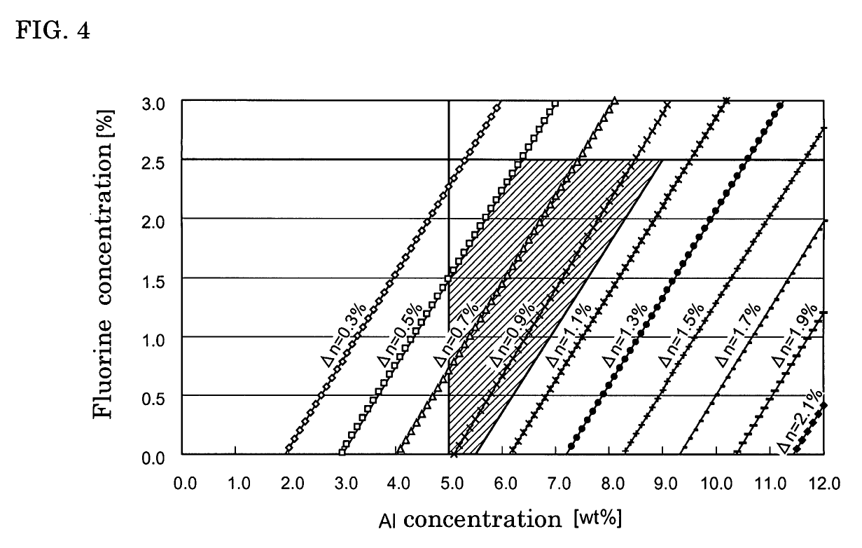

FIG. 4 is a graph showing relationships between Al concentration and fluorine concentration, using relative refractive index differences Δn as a parameter. Doping Al elements to the core region increases the relative refractive index difference Δn and decreases the mode field diameter MFD, thereby making the nonlinear optical phenomenon to occur easily. Therefore, a fluorine element which is effective for decreasing a refractive index is doped in order to restrain the increase of relative refractive index difference Δn due to Al-doping.

Table I shows the specifications (Core diameter: d_{c}, Er concentration: C_{Er}, Al concentration: C_{Al}, Fluorine concentration: C_{F}, Relative refractive index difference: Δn) of optical amplifier fibers in Examples of embodiments of the present invention and Comparative Examples.

TABLE I

| | d_{c} | C_{Er} | C_{Al} | C_{F} | | |
|---|---|---|---|---|---|---|
| | μm | wt. ppm | wt. % | wt. % | Δn % | η |
| Example 1 | 17 | 3000 | 5.0 | 0.7 | 0.60 | 0.0188 |
| Example 2 | 17 | 3000 | 6.5 | 1.4 | 0.85 | 0.0198 |
| Comparative | 17 | 3000 | 5.0 | 0 | 0.92 | 0.0210 |
| Example 1 | | | | | | |
| Comparative | 6.1 | 1500 | 5.5 | 0 | 1.05 | 1 |
| Example 2 | | | | | | |

The diameter of cladding is 125 μm in all cases. Here, nonlinear noise generation efficiency η of each optical amplifier fiber in Examples 1 and 2, and Comparative Examples 1 and 2 is standardized on the basis of the nonlinear noise generation efficiency of the optical amplifier fiber of Comparative Example 2, which was defined as 1.

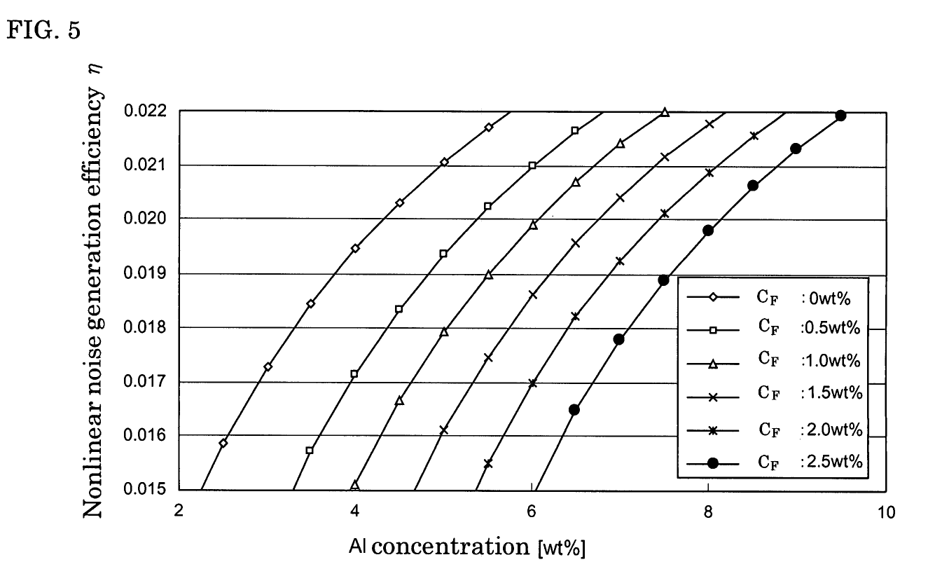

FIG. 5 is a graph showing relationships between Al concentration and nonlinear noise generation efficiency η, using fluorine concentration C_{F} as a parameter. Here, the core diameter was 17 μm. As Al concentration increases, nonlinear noise generation efficiency η increases, while nonlinear noise generation efficiency η decreases as fluorine concentration C_{F} increases. When Example 1 and Comparative Example 1 in which Al concentration is identical are compared, nonlinear noise generation efficiency η can be improved by about 10% by doping fluorine by 0.7 wt %.

Therefore, by doping the core region with required amount of fluorine as Al concentration is increased according to the increase of Er concentration, it is possible to restrain the increase of relative refractive index difference of the core region and restrain the decrease of mode field diameter MFD such that the occurrence of nonlinear optical phenomenon can be restrained.

(Embodiment of Light Source Equipment)

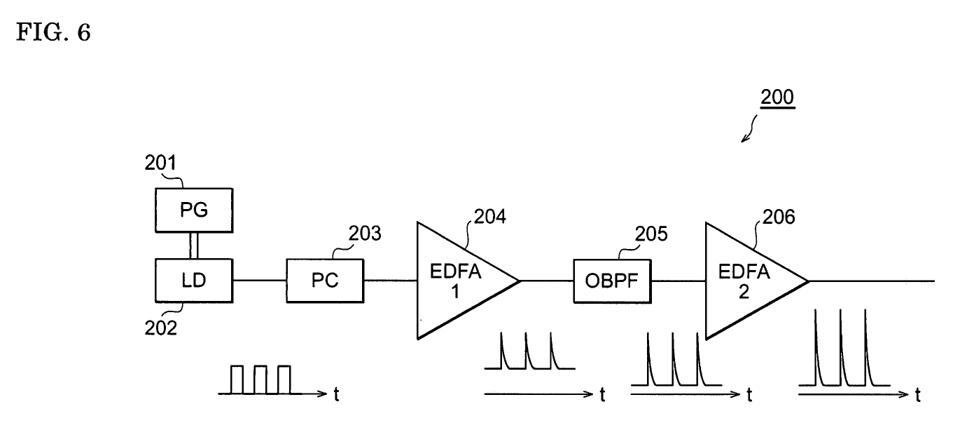

FIG. 6 is a schematic diagram of light source equipment 200 according to an embodiment of the present invention. The light source equipment 200, in which the optical amplifier fiber of the present invention is included, is a pulsed light source for outputting pulsed light.

The pulsed light source 200 comprises a pulse generator 201 which generates a rectangular electric pulse signal, a laser diode 202 which generates a rectangular light pulse based on the electric pulse signal, a polarization controller 203, a first erbium doped fiber amplifier (EDFA) 204, a band path filter 205 for removing amplified spontaneous emission (ASE) light, and a second EDFA 206 having an optical amplifier fiber of the present invention.

In the pulsed light source 200, an electric pulse signal of rectangular pulse shape generated in the pulse generator 201 is converted into an optical rectangular pulse by a laser diode 202. The light pulse output from the laser diode 202 is put into the first EDFA 204 through the polarization controller 203 and is amplified to be output as amplified pulsed light. The amplified pulsed light from the first EDFA 204 is removed of ASE light in the band path filter 205 and is input to the second EDFA 206 to be amplified so that pulsed light of high peak power is output.

Thus, with the pulsed light source 200 in which the second EDFA 206 uses the optical amplifier fiber of the present invention, the occurrence of nonlinear optical phenomenon can be restrained and pulsed light of high output power can be obtained.

The following is a description of embodiments of the optical medical treatment equipment and exposure equipment which use a pulsed light source 200 of the present invention.

(Embodiment of Optical Medical Treatment Equipment)

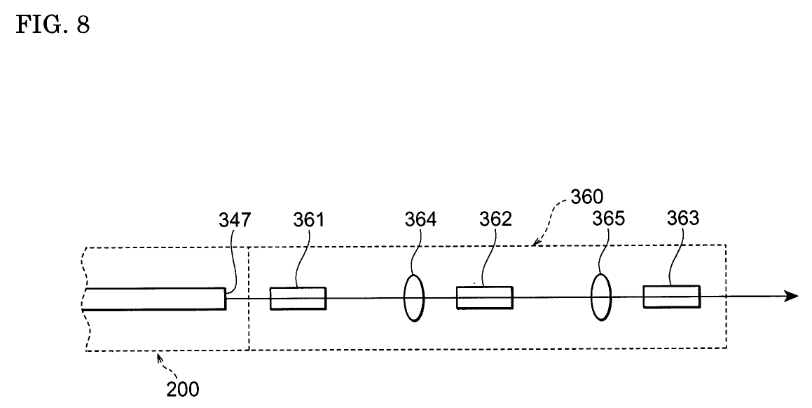

Next, in reference to FIGS. 8 to 10, optical medical treatment equipment according to an embodiment of the present invention will be described below. The optical medical treatment equipment according to the present embodiment comprises the pulsed light source 200. The optical medical treatment equipment is an apparatus with which shortsightedness, astigmatism, etc. are treated by correcting curvature or unevenness of a cornea by means of inner ablation (LASIK: Laser Intrastromal Keratomileusis) applied to a cut-opened cornea or surface ablation (PRK: Photorefractive Keratectomy) applied to a cornea surface by irradiating a laser beam to the cornea.

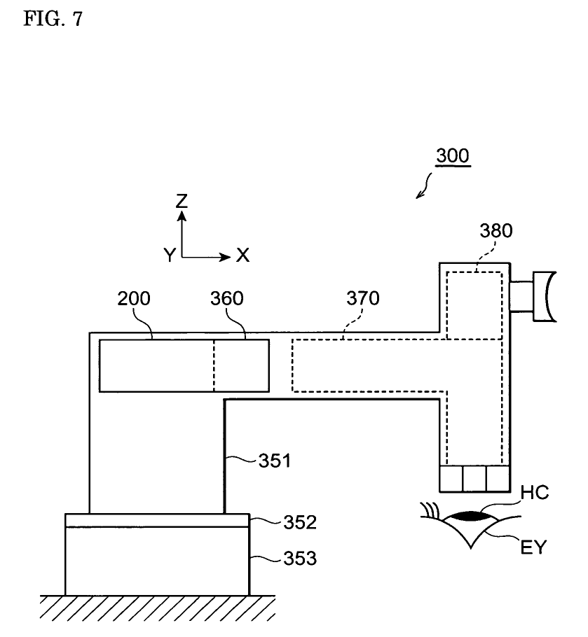

FIG. 7 is a schematic diagram of optical medical treatment equipment 300 according to an embodiment of the present invention. The optical medical treatment equipment 300 basically includes, in an equipment housing 351, a pulsed light source 200, a wavelength converter 360 in which a laser beam amplified and output by the pulsed light source 200 is converted into a laser beam having a desired wavelength, a luminaire 370 with which the laser beam whose wavelength has been converted by the wavelength converter 360 is led so as to be irradiated onto the surface (treatment region) of a cornea HC of an eye EY, and an optical observation device 380 for observing a treatment region. The base part 352 of the equipment housing 351 is disposed on an X-Y movement table 353 such that the whole equipment housing 351 can move in the X direction, i.e. a right-and-left direction in FIG. 7 and the Y direction which is perpendicular to the surface of the page on which the figure exists.

FIG. 8 is a schematic diagram of the wavelength converter 360 which is included in the optical medical treatment equipment 300. The wavelength converter 360 has nonlinear optical crystals 361, 362, and 363 and condensing lens 364 and 365 which are arranged between them. The laser beam (fundamental component) which is output from the output end 347 of the pulsed light source 200 is converted by the nonlinear optical crystals 361, 362, and 363 into a laser beam (harmonic component) having a desired wavelength for treatment. In this embodiment, the wavelength of the fundamental component is 1.544 μm, and the harmonic component, which is suitable for cornea treatment, is ultraviolet light of (193 nm) having the same wavelength as an Ar-fluorine excimer laser. The repetition frequency of the pulse oscillation of the harmonic component output from the wavelength converter 360 is very high, i.e., 100 kHz.

When the fundamental component passes through the nonlinear optical crystal 361, a double wave having a wavelength twice the frequency ω of the fundamental component (the wavelength is ½, i.e., 772 nm) occurs due to occurrence of a second harmonic. The second harmonic advances towards the right direction and is incident on the next nonlinear optical crystal 362. Here, the second harmonic generation is performed again, and a fourth harmonic having a frequency 4ω, which is 4 times relative to the fundamental component (the wavelength is ¼, i.e., 386 nm), i.e. twice the frequency 2ω of the incident wave, occurs. The fourth harmonic advances towards the nonlinear optical crystal 363 further to the right, and here again the secondary harmonic component generation is performed such that an octuple wave having a frequency 8ω, which is two times the frequency 4ω of the incident wave, i.e., 8 times the frequency of the fundamental component (the wavelength is ⅛, i.e., 193 nm), is generated.

The nonlinear optical crystals used for the conversion of wavelength are, for example, LiB₃O₅ (LBO) crystal for the nonlinear optical crystals 361 and 362, and Sr₂Be₂B₂O₇ (SBBO) crystal for the nonlinear optical crystal 363, respectively. Here in the conversion using LBO crystal from the fundamental component into the second harmonic, the temperature of the LBO crystal is controlled so that the fundamental component and the second harmonic component meet phase matching conditions. This is advantageous because the conversion from the first harmonic to the second harmonic can be accomplished at high efficiency since the angular deviation (walk-off) between the fundamental component and the second harmonic component does not occur, and also because the second harmonic thus generated does not suffer from the deformation of a beam due to walk-off.

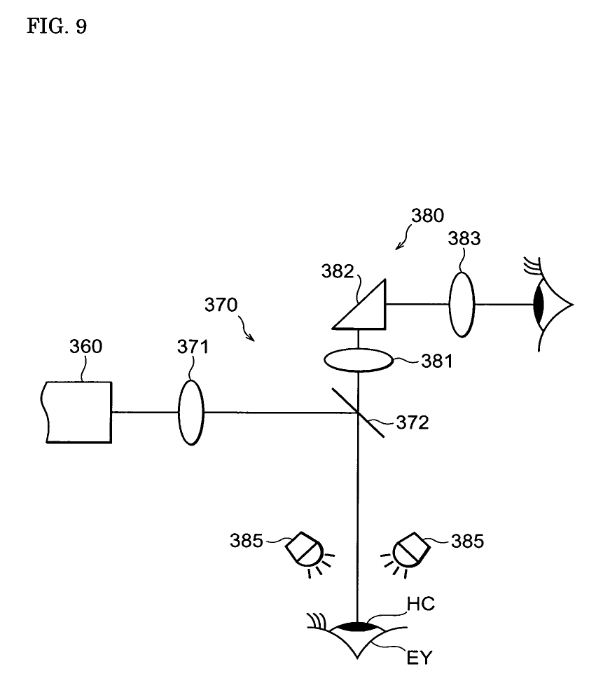

FIG. 9 is a schematic diagram of a luminaire 370 and an observation optical device 380 which are included in the optical medical treatment equipment. The luminaire 370 comprises a condensing lens 371 for condensing laser light of 193 nm wavelength, which is obtained by the wavelength converter 360 by converting the wavelength, into a thin beam, and a dichroic mirror 372 for reflecting and irradiating the laser beam thus obtained onto a treatment object, i.e., the surface of a cornea HC of an eye EY. Thus, the laser beam is irradiated as spot light to the surface of the cornea HC so that the transpiration of this part is performed. In this case, the whole equipment housing 351 is moved by the X-Y movement table 353 in the X direction and the Y direction so that the laser beam spot irradiated onto the surface of the cornea HC is scan-moved and an ablation is performed on the cornea surface, and thereby nearsightedness, astigmatism, hypermetropia, etc. are treated.

Such treatment is performed while the operation of the X-Y movement table 353 is controlled by a performing person such as an oculist through observation of the observation optical device 380. The observation optical device 380 comprises an illumination lamp 385 for illuminating the surface of a cornea HC of an eye EY to be treated, an object lens 381 which receives light through the dichroic mirror 372 from the cornea HC illuminated by the illumination lamp 385, a prism 382 for reflecting light incident from the object lens 381, and an eyepiece 383 for receiving the light. Thus, an enlarged image of the cornea HC can be observed through the eyepiece 383.

(Embodiment of Exposure Equipment)

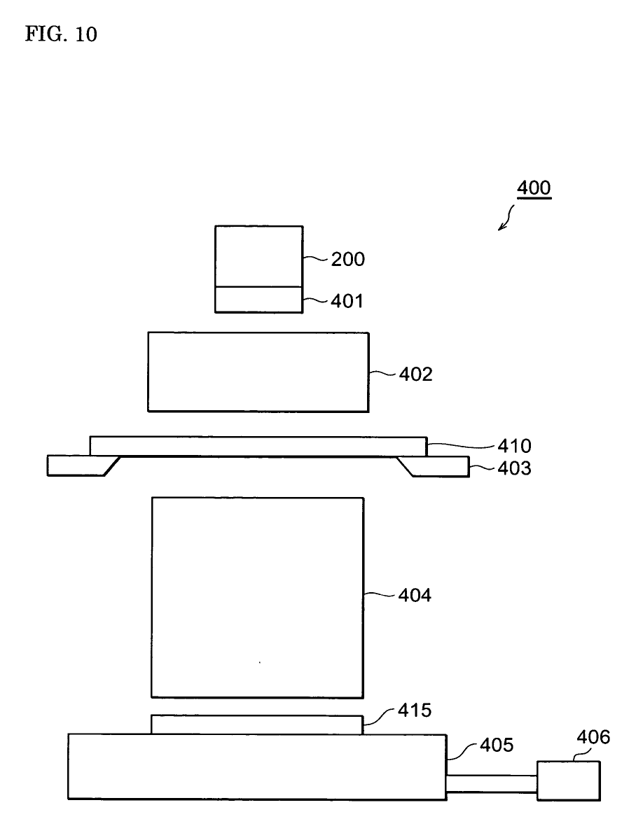

FIG. 10 is a schematic diagram of exposure equipment 400 according to the embodiment of the present invention. The exposure equipment 400 comprises a pulsed light source 200, and is used in a photolithography process, which is one of semiconductor manufacture processes. The exposure equipment used in the light lithography process is theoretically the same as photoengraving, and a device pattern precisely pictured on a photomask (reticle) is optically projected and transcribed onto a semiconductor wafer or a glass substrate on which a photoresist is applied. The exposure equipment 400 comprises the above-mentioned pulsed light source 200, a wavelength converter 401, an illumination optical system 402, a mask support stand 403 for supporting a photomask (reticle) 410, a projection optical system 404, a stage 405 for supporting a semiconductor wafer 415, and a driving unit 406 for horizontally moving the stage 405.

In the exposure equipment 400, a laser beam output from the output end of the pulsed light source 200 is input to the wavelength converter 401, and is converted into a laser beam having a needed wavelength for exposure of the semiconductor wafer 415. The laser beam thus converted in terms of wavelength is input to the projection optical system 402 composed of a plurality of lens, and is irradiated therethrough onto the whole surface of the photomask 410 supported the mask support stand 403. The light thus irradiated and passed through the photomask 410 has an image of the device pattern pictured in the photomask 410 and the light is irradiated through the projection optical system 404 onto a predetermined position of the semiconductor wafer 415 put on the stage 405. Then, the image of the device pattern of the photomask 410 is reduced to be formed and exposed on the semiconductor wafer 415 by the projection optical system 404.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims.

The entire disclosure of Japanese Patent Application No. 2005-145663 filed on 18 May, 2005 including specification, claims drawings and summary are incorporated herein by reference in its entirety.

What is claimed is:

1. An optical amplifier fiber comprising
(1) a core region doped with an aluminum element in the range of 1 wt % to 10 wt %, an erbium element in the range of 1000 wt. ppm to 5000 wt. ppm, and a fluorine element, and having an outer diameter in the range of 10 μm to 30 μm, and
(2) a cladding region surrounding the core region and having a refractive index that is lower than the core region,
and wherein the relative refractive index difference of the core region relative to the cladding region is 0.3% or more and 2.0% or less.

2. An optical amplifier fiber set forth in claim 1,
wherein the concentration of the erbium element is 2500 wt. ppm or more and 4000 wt. ppm or less.

3. An optical amplifier fiber set forth in claim 1,
wherein the concentration of the aluminum element is 4 wt % or more and 8 wt % or less.

4. An optical amplifier fiber set forth in claim 1,
wherein the concentration of the fluorine element is 0.1 wt % or more and 2.5 wt % or less.

5. An optical amplifier fiber set forth in claim 4,
wherein the concentration of the fluorine element is 0.3 wt % or more and 2.0 wt % or less.

6. An optical amplifier fiber set forth in claim 1,
wherein the relative refractive index difference of the core region relative to the cladding region is 0.3% or more and 1.0% or less.

7. An optical amplifier comprising:
(1) an optical amplifier fiber of claim 1, and
(2) a pump light supplying means for supplying pump light to the optical amplifier fiber.

8. Light source equipment comprising:
(1) a signal generator for generating an electrical signal,
(2) a semiconductor laser device for generating a laser beam based on the electrical signal, and
(3) an optical fiber amplifier for amplifying a laser beam emitted from the semiconductor laser device,
wherein the optical fiber amplifier comprises the optical amplifier fiber of claim 1.

9. Optical medical treatment equipment comprising:
(1) light source equipment of claim 8,
(2) a wavelength converter for converting irradiation light emitted from an outlet part of the light source equipment into irradiation light of a given wavelength for medical treatment, and
(3) an irradiation light system for leading and irradiating the irradiation light converted by the wavelength converter, onto a treatment part.

10. Exposure equipment comprising:
(1) light source equipment of claim 8,
(2) a wavelength converter for converting irradiation light emitted from an outlet part of the light source equipment, into irradiation light of a given wavelength,
(3) a mask supporting member for holding a photomask in which a pre-determined exposure pattern is provided,
(4) a holder for holding an object of exposure,
(5) an illumination optical system for irradiating irradiation light converted by the wavelength converter onto a photomask held by a mask supporting member, and
(6) a projection optical system with which irradiation light having been irradiated by the illumination optical system and having passed through the photomask is projected to an object of exposure held by an object holder.
